(19) United States
(12) Patent Application Publication
(10) Pub. No.: US 2013/0024118 A1
(43) Pub. Date: Jan. 24, 2013

(54) System and Method for Identifying Patterns in and/or Predicting Extreme Climate Events

(71) Applicants: Alexander Gershunov, La Jolla, CA (US); Kristen Guirguis, San Diego, CA (US)

(72) Inventors: Alexander Gershunov, La Jolla, CA (US); Kristen Guirguis, San Diego, CA (US)

(73) Assignee: THE REGENTS OF THE UNIVERSITY OF CALIFORNIA, Oakland, CA (US)

(21) Appl. No.: 13/522,682

(22) PCT Filed: Jan. 18, 2011
(86) PCT No.: PCT/US2011/021586

§ 371 Date: Oct. 2, 2012

Related U.S. Application Data
(60) Provisional application No. 61/296,016, filed on Jan. 18, 2010.

(51) Int. Cl. G01W 1/00; G06F 19/00

(52) U.S. Cl. 702/3

(57) ABSTRACT

A method and system are provided for medium-range probabilistic prediction of extreme temperature events. Extreme temperatures are measured according to how local temperature thresholds are exceeded on daily timescales to generate a local “Magnitude Index” (MI). A regional MI reflecting the historic temperature intensity, duration and spatial extent of extreme temperature events over all locations within the region is then computed. The regional MI is used to create a synoptic catalog for each of one or more pre-defined weather variables by testing the significance of leading modes in historic atmospheric variability across specified periods of time. Current or recent weather conditions are compared against the synoptic catalog to generate probabilistic predictions of extreme temperature events based the presence of synoptic precursors identified in historic patterns.

### RELATED APPLICATIONS

This application claims the priority of U.S. provisional application No. 61/296,016, filed Jan. 18, 2010, the disclosure of which is incorporated herein by reference.

### FIELD OF THE INVENTION

The invention relates to a method and system for use in identifying patterns in, and predicting, weather extremes and more particularly for a method and system for improved extended-range forecasts.

### BACKGROUND OF THE INVENTION

In the peak of summer, it is not uncommon for individuals to be unable to find a store with air conditioners or fans left in stock. In the dead of winter, when many people can be snowed in for days or weeks, they want to make sure they have enough basic supplies on hand and enough heating fuel to make it through to the thaw.

Extreme weather can cause extreme discomfort for individuals and extreme uncertainty when it comes to finances. From the superstore wishing it had planned to stock more winter coats to the homeowner concerned about his or her next energy bill, guessing wrong on weather can become a disaster for business and consumer budgets alike.

As global climate change progresses, increases in extreme weather events are being experienced worldwide. Scientists and meteorologists expect that severe-weather events such as heat waves in the Midwest and Northeast United States will become more frequent. Massive flooding from intense storms has devastated large areas of Australia and regions in Asia. Recent severe winter storms have repeatedly paralyzed the Midwest and much of the East Coast of the U.S. Lives are lost, homes and property are destroyed, transportation is crippled, emergency response is slowed or prevented, long term power outages occur, and countless other normal daily activities are impacted, costing millions of dollars in damage and lost business opportunities. Extreme cold spikes in wintertime temperature increase demand for heating which, in turn, leads to greater usage of commodities such as oil and natural gas, while extreme heat spikes increase electricity consumption, leading to the need for rolling brown-outs to prevent grid overload. It has been said that weather is the most volatile external factor that influences consumer and market behavior. In addition to the impact on heating fuels and electricity consumption, weather-driven demands are seen in products including clothing, food items, hardware and electronics. Large-scale climate information can be used to condition medium-range weather forecasts in order to gain skill in predicting these extreme temperature events to allow individuals, businesses and governments to prepare themselves to minimize the impact of these events on health, safety, property and commerce.

Existing commercially-available weather prediction products are offered by private weather forecasting firms including Accuweather, Weather Services International (WSI Corporation), Meteorlogix, MDA Federal EarthSat, AER Inc., Freese-Notis, IPS Meteostar, Planalytics Inc. and others. The software products and services offered by these companies are designed to allow businesses to predict opportunities, e.g., increased demand, or conversely, lags in demand, for goods or services, and risks, e.g., delays in construction projects, associated with weather events. Some are directed to the aviation industry, while others may be specialized for the needs of agriculture or construction businesses. However, because weather is a highly complex process that is forced by a large number of variables, it can be difficult to precisely model it by creating a mini-atmosphere in computer models, which is the primary approach for currently-available products.

Short-range winter storm warnings have become much more accurate in recent years, allowing governmental and agencies to issue warnings, stage heavy equipment, and prepare shelters in anticipated of extreme events. Nonetheless, forecasts with lead times on the order of two-weeks to a month remain a challenge. Relationships with climate modes such as the ENSO (El Niño/Southern Oscillation), NAO (North Atlantic Oscillation), PNA (Pacific North American), etc. have been explored, and some rules-of-thumb exist for assessing the winter outlook. Unfortunately, these rules-of-thumb do not always hold, creating variable and often low confidence in medium-range to seasonal scale forecasts.

There are many studies in the literature that look at the relationship between precursor weather or climate features and severe cold snaps. Many studies have focused on individual storms or seasons (e.g. Wagner 1977, Quiroz 1984, Mogil et al. 1984, Bosart and Sanders 1986, Konrad and Colucci 1989), which have provided valuable information towards understanding the evolution of cold outbreaks. Others have looked at multiple storms over the long-term record providing more general conclusions about contributing precursors and therefore predictability. For example, Rogers and Rohli (1991) identified preferred tracks of polar anticyclones leading to major Florida citrus freezes from 1889-1990 and noted a relationship between such freezes and the Pacific North American (PNA) teleconnection pattern. Downton and Miller (1993) reported a relationship between the Florida citrus freezes and the PNA and NAO but no direct relationship with ENSO. Konrad (1996) studied the relationship between cold snaps in the southeastern U.S. and the evolution of synoptic- and planetary-scale features over North America for the 1970-1990 period using a lag correlation analysis. The correlation maps from these studies showed important relationships between persistent North American patterns and southeastern U.S. temperatures, including positive surface pressure (negative 500 mb height) anomalies over western Canada (the Great Lakes) 6-12 days prior to onset. Grumm and Hart (2001) used NCEP (National Centers for Environmental Prediction, National Oceanic and Atmospheric Administration) Reanalysis data over the domain of the U.S. to study cold season weather events in Pennsylvania during 1964-2000. They presented a method of standardizing synoptic weather fields to serve as guidance to forecasters in identifying unusual departures from normal, and showed that severe cold spells over Pennsylvania tend to be associated with very strong atmospheric/surface anomalies (-2.5 standard deviations). Walsh et al. (2001) used NCEP Reanalysis data for 1948-1999 to study extreme cold outbreaks in subregions of the U.S. and Europe. This analysis used the ten coldest one-, three-, and five-day events in each region (Eastern, Midwestern, and Gulf Coast U.S., and Northern and Western Europe) and they provided sea level pressure anomaly maps representing composites of the surface conditions at 0-10-day leads noting differences between events occurring in different regions. Walsh et al. (2001) also looked at climate indices at 0-12 day leads and showed that negative values of the North Atlantic Oscillation (NAO) and positive values of Arctic sea level pressure were common precursors to cold outbreaks in the U.S. and Europe.

Academic studies have provided invaluable information towards improving the understanding of cold air outbreaks. There are many findings and rules-of-thumb relating local or remote weather and climate features to severe cold outbreaks, but these relationships do not hold for all events, which presents difficulties for operational meteorologists. Another shortcoming is that these results are static (journal printings) and are often specific to a focused geographic region.

Comprehensive probabilistic tools relating weather/climate conditions to historical cold air outbreaks would help to improve predictions in both accuracy and lead-time, however, such comprehensive probabilistic information is not readily available. The present invention is directed to this need.

### SUMMARY OF THE INVENTION

The present invention provides statistical and empirical frameworks to improve the lead-time and skill of extended range weather forecasts. The method and system according to the present invention, tools are provided for providing seasonal to multi-year weather predictions based on statistical modeling of climate variability.

In an exemplary embodiment, the present invention collects and processes extreme temperature data to provide a comprehensive definition to examine the variability of regional cold extremes and uses statistical tools to investigate causality and create a framework to develop models for skillful seasonal-to-interannual predictability, on a probabilistic basis, for regional cold outbreaks. The inventive method then examines synoptic causes and precursors of individual regional cold events to create a tool for extended forecasts.

The inventive method uses temperature records (temperature, time, location, etc.) from single or multiple locations as a basic input into a central processor to generate analytic catalogs used for predicting extreme incidents of warm or cold weather. The data may be input directly from the different data collection stations or can be stored in a memory associated with the processor.

The inventive process considers extreme temperatures according to how local temperature thresholds are exceeded on daily timescales. A regional “Magnitude Index” (MI) reflecting the temperature intensity, duration and spatial extent of extreme temperature events is computed. Observed variability of temperature extremes is then examined on timescales ranging from days to decades and scrutinized with respect to the climate controls on their synoptic causes. Relationships with known climate models as well as other relevant objectively derived circulation and land-surface patterns may be then used to develop analytic catalogs that can lead to improved medium-range probabilistic prediction for extreme temperature events. Long-term trends may be assessed and integrated into the predictive methodology. The main components of cold temperature extremes, i.e., intensity, duration and spatial extent, are explicitly considered.

In one aspect of the invention, a method is provided for prediction of extreme weather events, by generating a catalog of synoptic precursors by: collecting historical weather data over a period of record for one or more selected regions, the data comprising intensity, duration and spatial extent, wherein a plurality of local data sources are located within the one or more selected regions; calculating a local magnitude index for each local data source; calculating a regional magnitude index using the local magnitude index for the plurality of local data sources within the selected region; using the magnitude index to perform one or more of the following: creating composite maps of global weather patterns at leading and lagging timescales for one or more pre-defined weather variables; generating significance plots of the significance of leading modes in atmospheric variability across the period of record for the one or more pre-defined weather variables; generating time series graphical plots and event sets which define independent events according to intensity, spatial extent and duration for different durations and dates for the one or more pre-defined weather variables; generating a synoptic catalog for each of the one or more pre-defined weather variables by testing the significance of leading modes in atmospheric variability across a user-defined period of time; and generating a graphical display at a user interface of one or more of the composite maps, significance plots, time series graphical plots and the synoptic catalog for use in a probabilistic projection that an extreme weather event will occur based on recent or current weather conditions.

In another aspect of the invention, a system is provided for prediction of extreme weather events, wherein the system includes a central server; a database for storing historical weather data comprising intensity, duration and spatial extent of weather conditions; a plurality of local measurement stations disposed within one or more regions; a user interface comprising a graphical display; a networked connection providing data communication between the central server, the database, the plurality of local measurement stations and the user interface, wherein the central server is programmed to execute the steps of: collecting historical weather data over a period of record for the one or more regions, the data comprising intensity, duration and spatial extent; calculating a local magnitude index for each local measurement station; calculating a regional magnitude index using the local magnitude index for the plurality of local measurement stations within the one or more regions; and using the magnitude index to perform one or more of the following: creating composite maps of global weather patterns at leading and lagging timescales for one or more pre-defined weather variables; generating significance plots of the significance of leading modes in atmospheric variability across the period of record for the one or more pre-defined weather variables; generating time series graphical plots and event sets which define independent events according to intensity, spatial extent and duration for different durations and dates for the one or more pre-defined weather variables; generating a synoptic catalog for each of the one or more pre-defined weather variables by testing the significance of leading modes in atmospheric variability across a user-defined period of time; and generating a graphical display at the user interface of one or more of the composite maps, significance plots, time series graphical plots and the synoptic catalog for use in a probabilistic projection that an extreme weather event will occur based on recent or current weather conditions.

In still another aspect of the invention, a computer program product embodied on a computer readable medium for predicting extreme weather events, includes instructions for causing a computer processor to: collect historical weather data over a period of record for one or more selected regions, the data comprising intensity, duration and spatial extent, wherein a plurality of local data sources are located within the one or more selected regions; calculate a local magnitude index for each local data source; calculate a regional magnitude index using the local magnitude index for the plurality of local data sources within the selected region; using the magnitude index to perform one or more of the following: create composite maps of global weather patterns at leading and lagging timescales for one or more pre-defined weather variables; generate significance plots of the significance of leading modes in atmospheric variability across the period of record for the one or more pre-defined weather variables; generate time series graphical plots and event sets which define independent events according to intensity, spatial extent and duration for different durations and dates for the one or more pre-defined weather variables; generate a synoptic catalog for each of the one or more pre-defined weather variables by testing the significance of leading modes in atmospheric variability across a user-defined period of time; and generate a graphical display at a user interface of one or more of the composite maps, significance plots, time series graphical plots and the synoptic catalog for use in a probabilistic projection that an extreme weather event will occur based on recent or current weather conditions.

The inventive method and system capture a dynamic and comprehensive probabilistic tool that can be adapted to focus on severe temperature (warm or cold) over a user-defined region of interest, and which includes hemispheric or global weather data for multiple variables.

### BRIEF DESCRIPTION OF THE DRAWINGS

FIG. 1 is a block diagram of an exemplary system for providing the inventive tool for extended forecasting.

FIG. 2 is a block diagram showing the process flow according to the present invention.

FIG. 3 is a graphical representation of an exemplary temperature magnitude index (“MI”) for severe cold events.

FIG. 4 illustrates an example of a probablistic composite map for 850 mb air temperature at a 5-day lead-time to temperature event.

FIG. 5 is an image of an exemplary page from the synoptic catalog for 500 mb geopotential height for the 1981-1982 winter season.

FIG. 6 is a series of exemplary images showing the significance of leading modes for 500 mb geopotential height with respect to the occurrence of sever weather.

FIG. 7 is an example of a probability plot showing the percent chance that extreme temperatures followed each of nine identified weather patterns in their positive or negative phases.

FIGS. 8a and 8b are plots of observed daily mean temperature (8a) and temperature anomalies (8b) for each date in winter as measured at a selected station.

FIG. 9 is a plot of event maximum SCI and duration for five different groups of events.

FIG. 10 plots the Magnitude Index (MI) for the different groups of FIG. 9.

FIGS. 11a-11c are plots of synoptic precursors for 500 mb geopotential height.

FIG. 12 is a plot comparing the magnitudes in weather pattern for sea level pressure relative to a threshold of 1 standard deviation.

FIG. 13 illustrates an example of a page from a synoptic catalog according to the present invention.

FIG. 14 is a plot of seasonal severe cold index (SCI) and severe warm index (SWI) for the Northern Continents.

FIG. 15 is a plot of daily SCI and SWI for the winter of 2009-2010 for the Northern Continents.

FIG. 16 is a plot of the spatial extent (as proportion of continental area) versus intensity of warm and cold extremes for the Northern Hemisphere.

### DETAILED DESCRIPTION

References to “NCEP data”, “NCAR data”, and “NCEP/NCAR Reanalysis data” will be understood by those in the art to refer to Internet-accessible data products representing the state of the Earth's atmosphere, which are available through the NCEP/NCAR Reanalysis Project of the United States Department of Commerce/National Oceanic and Atmospheric Administration/Earth System Research Laboratory/Physical Sciences Division. “NCEP” means the National Centers for Environmental Prediction and “NCAR” means the National Center for Atmospheric Research.

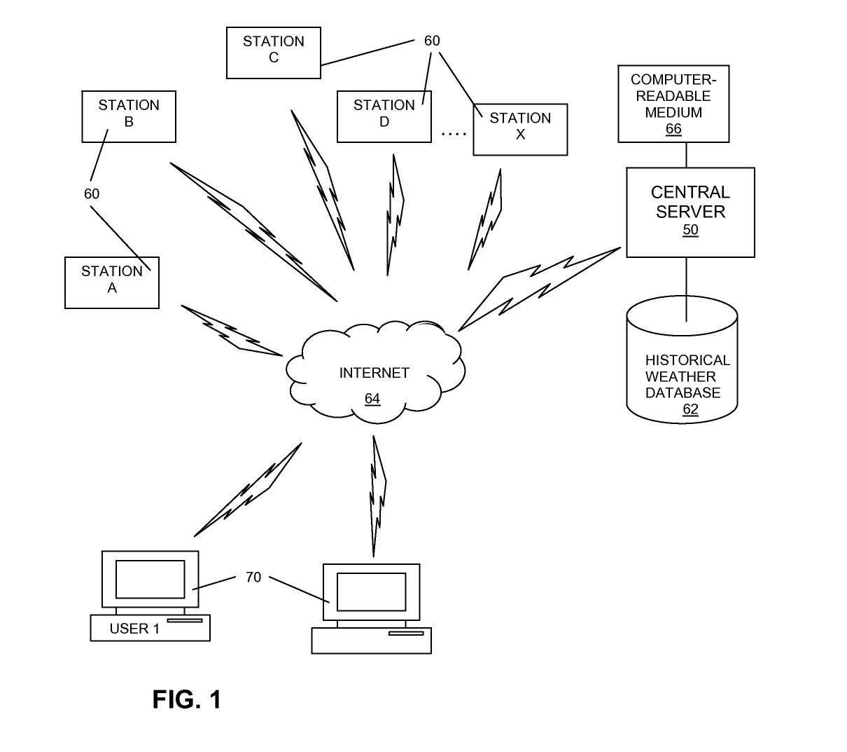

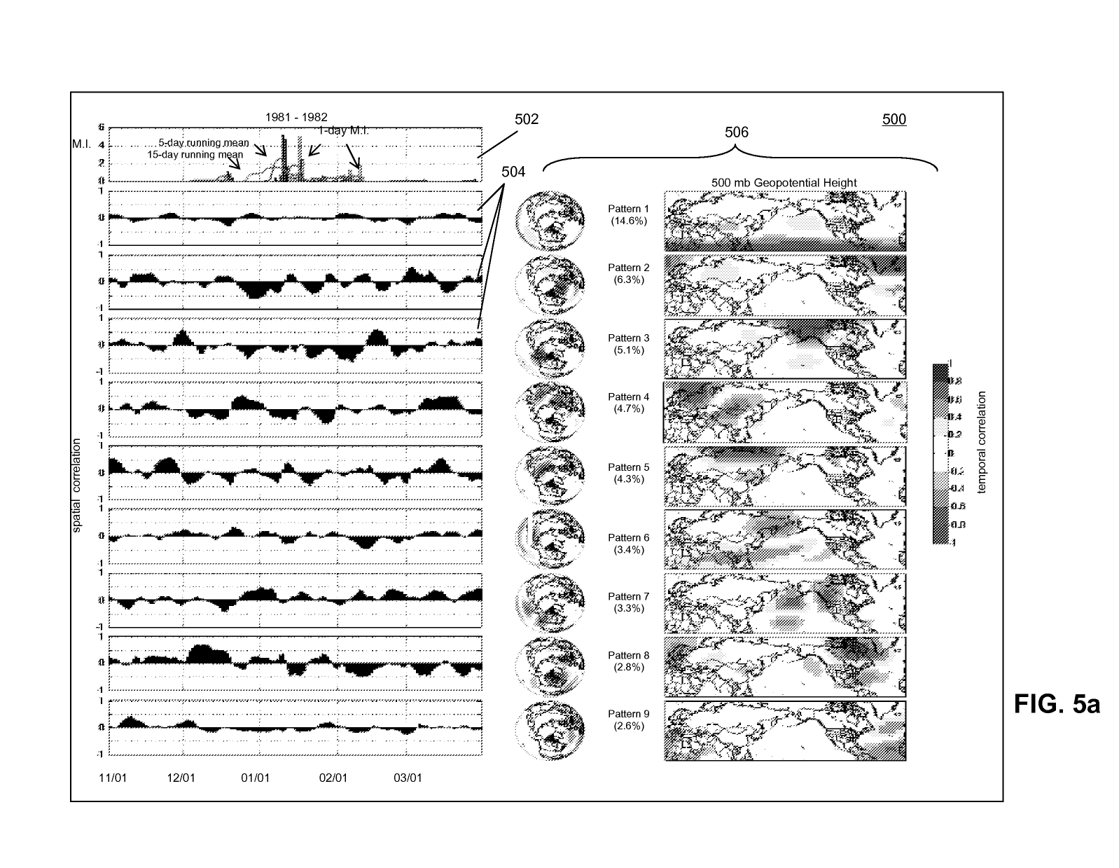

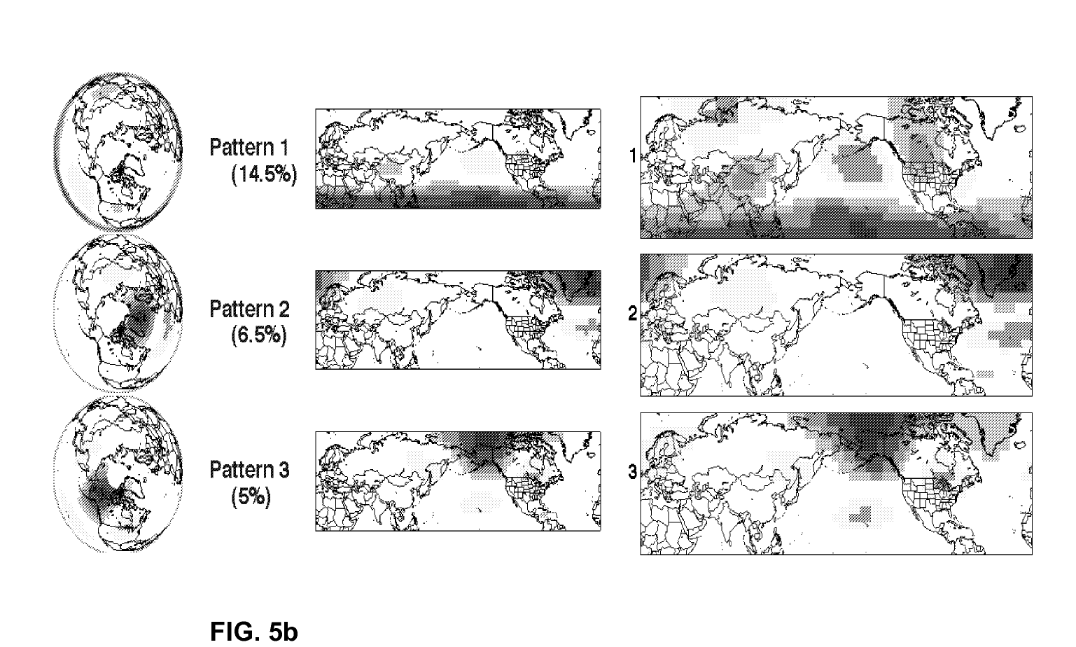

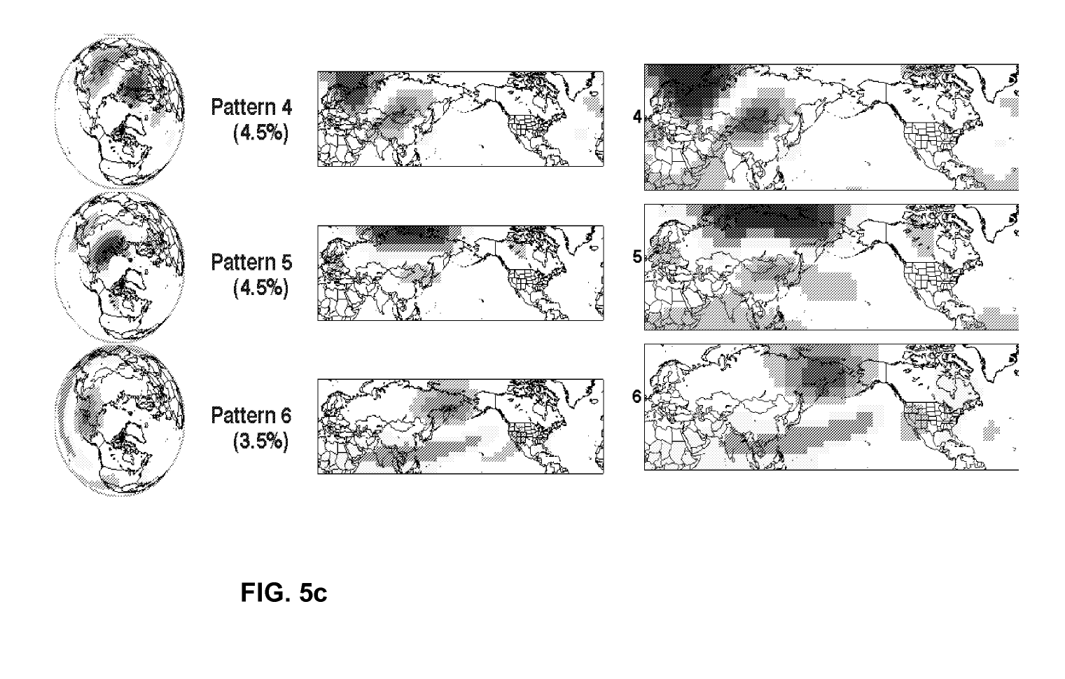

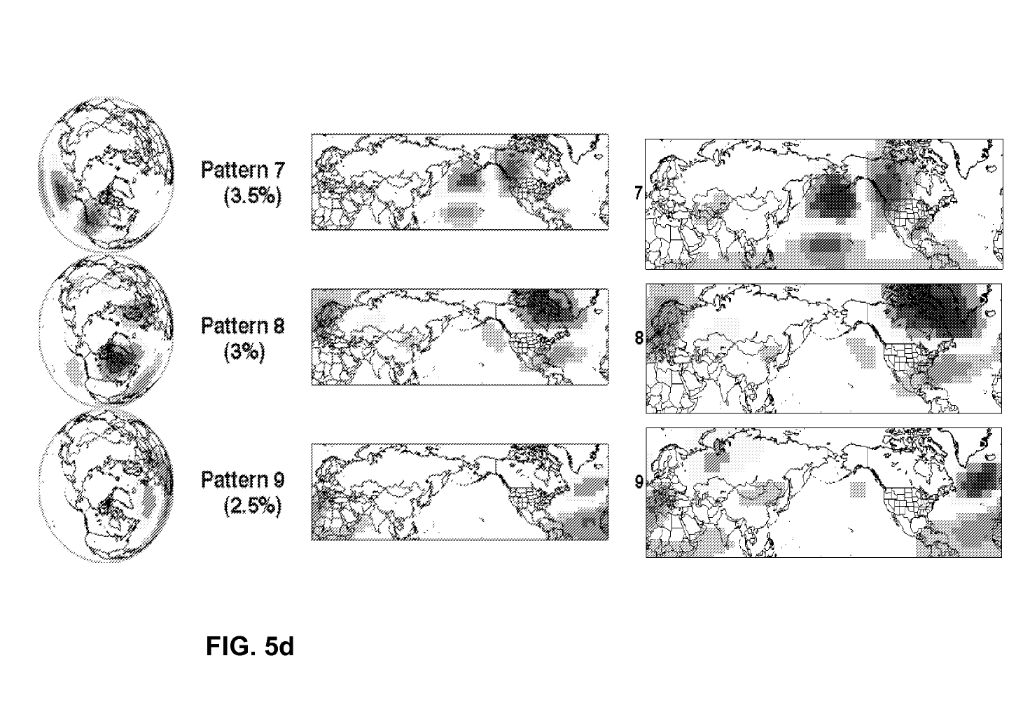

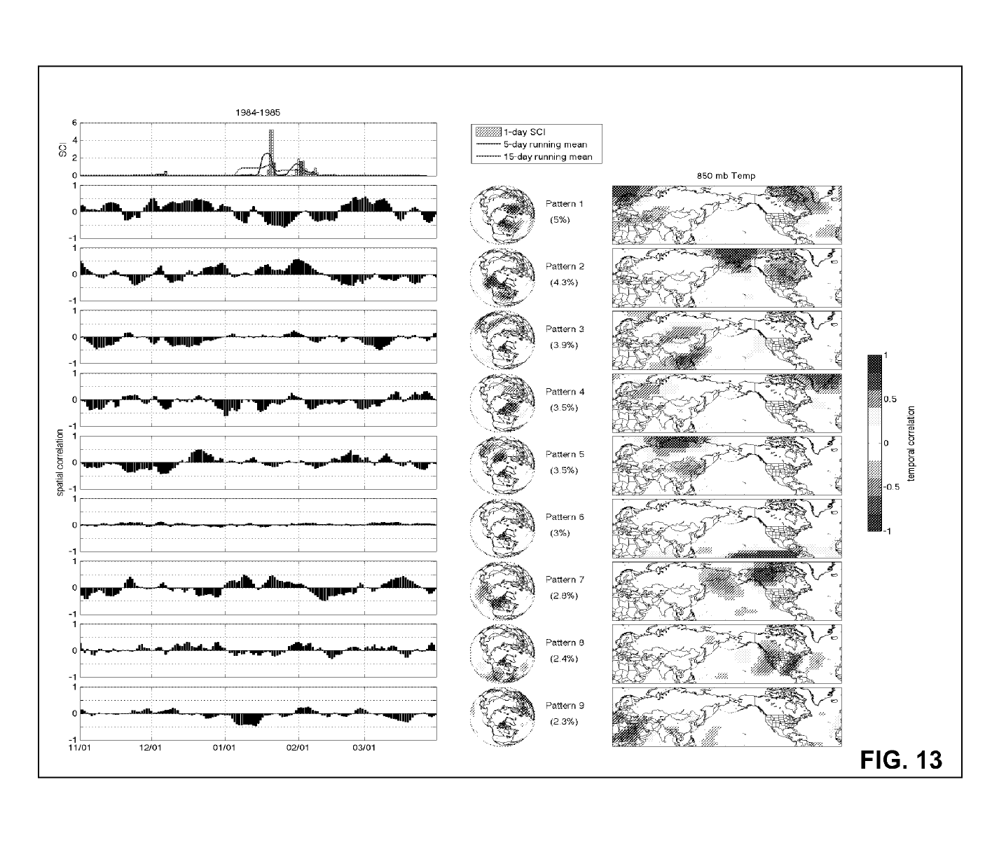

FIG. 1 illustrates an exemplary network platform for implementing the tool according to the present invention. The central server 50 may obtain the temperature/time/location data directly from stations 60 that collect the data. The stations may be distributed across any geographical area of interest, including globally. While historical weather data is typically stored within a weather/climate database 62 to which a central server 50 has access, for example, via the Internet 64, satellite or other networked system. Alternatively, the data may be stored on a computer-readable medium 66, including but not limited to CD/ROM, tape, hard drive, flash drive, magnetic, or other known data storage medium. The central server 50 includes software for executing the process described in more detail below. This software may also be embodied in a computer-readable medium. The user may access the data via a user interface 70 on a computer or workstation that is connected to a network through which the central server is accessible, e.g., the Internet. The user interface 70 provides instructions for entry of the desired locations, dates, duration and other parameters for obtaining the report for the location and time period of interest. These requests are processed at the central server and returned to the user in the form of one or more catalog pages with graphics and plots illustrating the patterns that may then be used to prepare an extended forecast for the area of interest. Exemplary catalog pages are provided as FIGS. 5a-5d and 13. Alternatively, the software for executing the steps for producing the catalog can be stored within the memory of a single workstation or personal computer which can then directly access the station data and/or the historical database to obtain the data necessary for producing a report for the location and time period of interest.

Alternative network structures and processing platforms will be readily apparent to those of skill in the art.

Short-term temperature extremes, both hot and cold, are highly sensitive to climate time scales as climate variability and change effect both the mean and variance structure of daily temperatures as they evolve over a season. The inventive process considers extreme temperatures according to how local temperature thresholds (n* percentiles of local temperature recorded at a number of stations, where *n is a user-defined variable) are exceeded on daily timescales. A regional “Magnitude Index” (MI) is computed to reflect the temperature intensity, duration and spatial extent of extreme temperature events. Observed variability of temperature extremes are then examined on timescales ranging from daily to interdecadal and scrutinized with respect to the climatic controls on their synoptic causes. Relationships with known climate modes as well as other relevant objectively derived circulation and land-surface patterns are then used to develop analytic catalogs that can lead to improved medium-range probabilistic prediction of extreme temperature events. Long-term trends are assessed and integrated into the predictive methodology. The main components of temperature extreme, i.e., intensity, duration and spatial extent, are explicitly considered. These forecasting tools are designed for straightforward operational application by practicing meteorologists.

The inventive method takes a unique approach in using precursor weather information to generate analytic catalogs that can serve as a basis for predicting extreme temperature events. The process results in several primary outcomes that are not currently available. The inventive process includes the steps of :

transforming temperature data into a “magnitude index” (“MI”); and

a) using the magnitude index as the basis for creating composites of global weather patterns at leading and lagging timescales. The output is labeled “Composite Maps” and can be generated for any weather variable defined within the NCEP NCAR Reanalysis Project.

b) using the MI as the basis for testing the significance of “leading modes” in atmospheric variability across the entire period of record. This output is labeled “Significance Plots” and can be generated for any weather variable defined within the NCEP NCAR Reanalysis Project.

c) using the MI to create series of unique data representations: (i) basic time series graphical plots; (ii) tabular “event set” catalogs defining independent events along with their characterization expressed through variables such as total magnitude, duration, spatial extent, single day magnitude, multi-day magnitude, start date, peak date, end date; (iii) event groupings by magnitude, duration and/or spatial extent.

d) using the MI as the basis for testing the significance of “leading modes” in atmospheric variability for user defined periods of time. This output is labeled the “Synoptic Catalog” and can be generated for any weather variable defined within the NCEP NCAR Reanalysis Project.

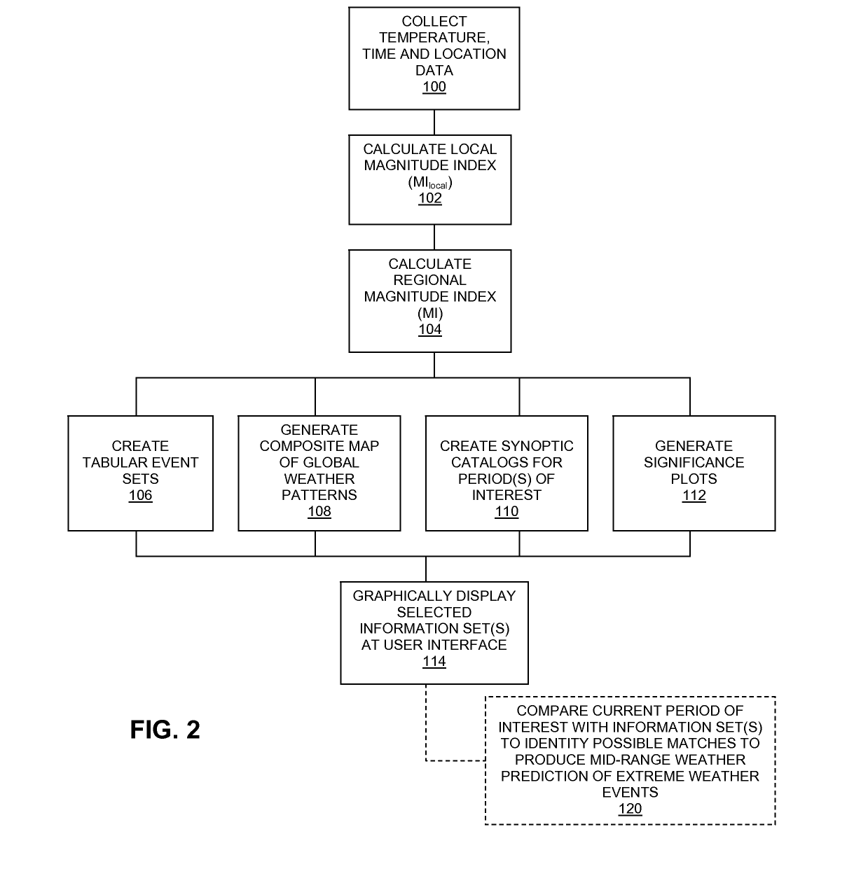

Referring to FIG. 2, the inventive process first collects temperature, time and location data from stations within the region(s) of interest (step 100). This data may include historical and recent measurements.

### Calculation of the Magnitude Index (Steps 102 & 104)

Regional cold temperature extreme magnitude is defined based on local threshold exceedance, as described by Gershunov et al. (“The Great 2006 Heat Wave over California and Nevada: Signal of Increasing Trend, Journal of Climate, 22:6181-6203, 2009) (incorporated herein by reference) to define heat waves, which is then aggregated to define a regional magnitude to reflect the event's intensity, duration and spatial extent. To illustrate, for a heat wave magnitude M (° C.), locally (at station j=1, . . . , N, where N=95), on a particular date d (e.g., the kth day of the 92 days of summer) of a particular summer s (year), M₉₉^{j,s,d} is the exceedance over the local 99^{th} percentile T₉₉^{j}, computed for the base period of the number of summers. Thus, M₉₉^{j,s,d}=(T_{s,d,j}−T₉₉^{j}) if T_{s,d,j}>T₉₉^{j}, and zero otherwise. These local daily values are aggregated over space (all stations j=1, . . . , N) and time (e.g., all summer dates d=1, . . . , 92 or other specified duration: s*, d*) by summation over the subscripted parameters. Asterisks refer to the specific summer and days spanned by a particular event. Regional magnitudes can be computed only using local magnitudes when the percentile threshold temperature is exceeded for at least n consecutive dates.

The Table 1 provides the formulas for determining magnitude M for different time periods locally and regionally for the 99^{th} percentile. As will be apparent, different thresholds may be selected.

TABLE 1

| Magnitude | Daily | Seasonal | Event |
|---|---|---|---|
| Local | M₉₉^{j, s, d} = | M₉₉^{j, s} = | M*₉₉^{j} = |
| | (T_{s, d, j} − T₉₉^{j}) | Σ_{d}(M₉₉^{j, s, d}) | Σₛ*_{,d}*(M₉₉^{j, s, d}) |
| Regional | M₉₉^{s, d} = | M₉₉^{s} = | M*₉₉ = |
| | Σⱼ(M₉₉^{j, s, d})/N | Σ_{j, d}(M₉₉^{j, s, d})/N | Σ_{j, s}*_{, d}*(M₉₉^{j, s, d})/N |

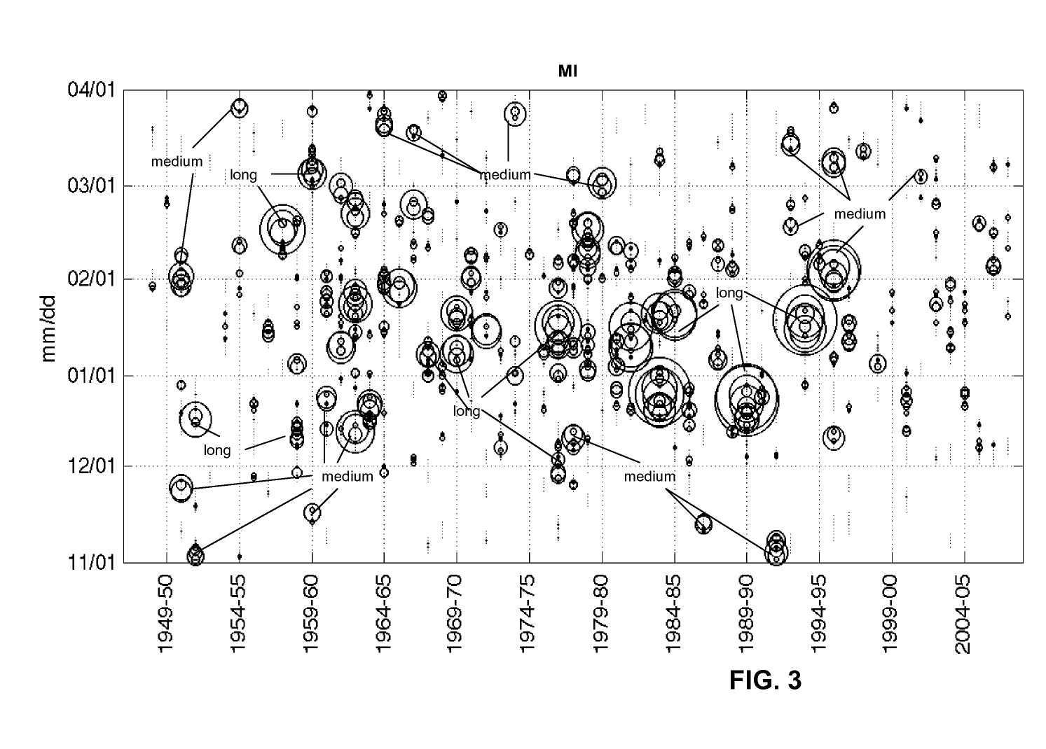

At each station, the seasonal cycle is removed from daily mean temperatures by fitting and subtracting a double harmonic cycle. The local “Magnitude Index” (MI) is then calculated for each station as the number of degrees above/below the n^{th} percentile. The regional MI magnitude index is the domain average of the local MI. The MI may be used to generate a graphical representation of historical evolution. FIG. 3 provides an example plot generated for severe cold events calculated for the eastern United States showing its historical evolution from the winter of 1948-49 to the winter of 2004-05. The circle size represents magnitude. Similar plots may be created for a user-defined domain for other types of extreme events such as heat waves.

The following steps use the MI to define a number of different information sets, which may be created in any order. The user may choose to generate any or all of the following sets depending on the desired knowledge to be obtained.

### Create Tabular Event Sets (Step 106)

The tabular event set contains information about each extreme temperature event, where the events included are those with at least 5 consecutive days of a non-zero regional MI. “Duration” is the number of consecutive non-zero days. “Event Sum” is the MI summed over the duration of the event. “Spatial extent” is proportion of stations in the region having a non-zero MI on the most extreme day of the event. “Max MI-1” is the most extreme day within the event. “Max MI-5” is the most extreme 5-day sum within the event. “Max MI-15” is the most extreme 15-day sum within the event. “Date Start” is the first non-zero day. Date End is the last non-zero day. Peak Date is the most extreme day within the event. Event Group gives the classification of events based on common criteria. Such groupings may be made to classify events based on a criteria or set of criteria of interest to the user. For example, grouping by magnitude and duration may be used to study differences in synoptic precursors leading to weaker/shorter cold outbreaks versus those leading to stronger/longer outbreaks.

The tabular data sets provide the user with valuable historical information about extreme temperature events, which can be sorted or otherwise manipulated.

### Generate Composite Maps (Step 108)

Composites may be created to provide information about the atmospheric/surface anomaly patterns at a range of lead times relative to extreme temperature events. Composites can be used to generate animations of evolving, leading weather conditions, and can be compared directly to weather forecast products. The composites described below are designed as a reference against which to compare weather forecasts to assess the likelihood of an extreme event given the projected atmospheric conditions. The effect is to improve the confidence and lead-time of medium-range forecasting of extreme temperatures.

Two types of composites may be constructed: A) Mean atmospheric/surface state leading events; and B) Probabilistic atmospheric/surface state leading events;

Mean atmospheric/surface state leading events composites may be constructed as follows:
1. The start and peak of each historical event is identified using the regional MI;
2. The atmospheric/surface state based on NCEP Reanalysis at 0-40 days prior to the start/peak of each event is identified;
3. The mean of the identified atmospheric/surface states leading to severe outbreaks is presented graphically. These plots include statistical significance of anomaly patterns based on the 95^{th} percentile using randomly selected days with the appropriate monthly distribution.

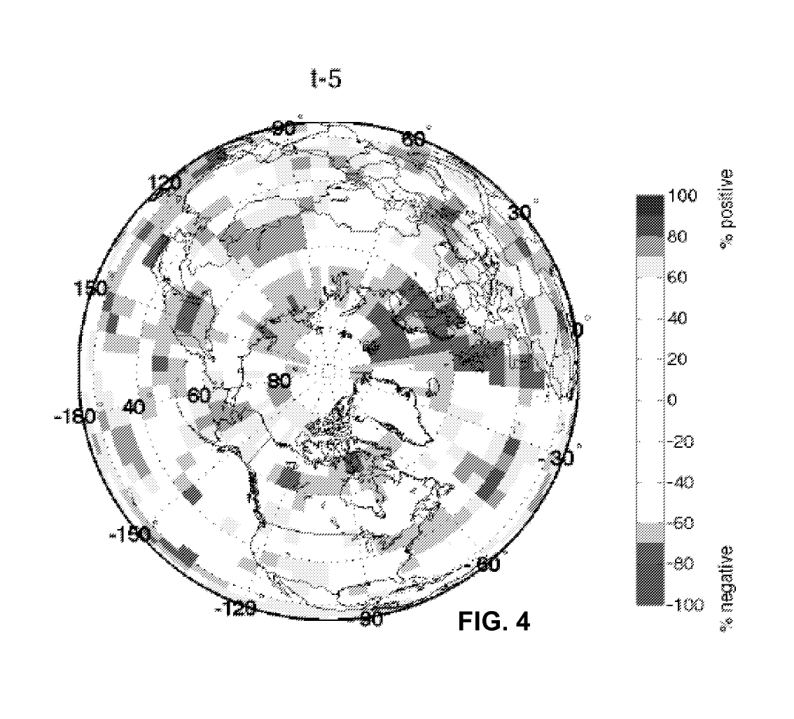

Probabilistic atmospheric/surface state leading events composites may be generated by the following steps:
1. The start and peak of each severe event is identified using the MI.
2. The atmospheric/surface state based on NCEP Reanalysis at 0-40 days prior to the start/peak of each event is identified
3. The probabilistic atmospheric/surface state leading to severe outbreaks is presented graphically (i.e., percent occurrence of a positive versus negative anomaly at a given point on the globe at 0-40 days lead).
   FIG. 4 provides an example of a probabilistic composite for 850 millibar (mb) air temperature at a five day lead-time (t-5) to temperature event. The percent (%) positive/negative refers to the percentage occurrence that a given point on the globe was experiencing a positive or negative anomaly.

### Create Synoptic Catalogs (Step 110)

Synoptic models of atmospheric phenomena and dynamical or physical processes have been used extensively to communicate the results of diagnostic research and help develop the science and art of weather forecasting. Using the MI, synoptic catalogs may be developed for user-specified windows of time. Rotated principal components analysis (PCA), also known in the art as empirical orthogonal function (EOF) analysis, may be applied to Reanalysis data to identify the dominant modes of variability observed in the time window of interest. A selected number of principal components representing a specified range of explained variance are retained and rotated. Eigenvalue spectra are visually inspected for degeneracy above a truncation point and each of the rotated principal components (RPCs) may be compared against raw data to ensure that extracted patterns are physically meaningful and not uncorrelated noise. The rotated empirical orthogonal functions (REOFs) and there corresponding RPCs give the spatial representation of synoptic weather patterns and their evolution over time.

Each synoptic catalog provides spatial and temporal information about the dominant weather variability patterns in relation to the MI in a given season. To identify common synoptic precursors to extreme weather events, the lag/lead relationships between the MI and RPCs for each atmospheric/surface variable is explored. Specifically, synoptic events are discretized by grouping consecutive days having like-signed pattern anomalies (RPCs in their positive or negative phase) into a discrete event. A synoptic event of a given magnitude is said to occur if, at some point during the event, the absolute magnitude of the RPC time series exceeds a threshold (e.g., 1 or 2 standard deviations (SD)). The probability that a positive MI, i.e., at least one extremely cold or hot day, was observed following a synoptic pattern (measured from the date of the threshold crossing) is then calculated. While the use of the threshold crossing as the start date of a synoptic event generally increases probabilities, it also reduces lead-time since the weather pattern may be contributing to the extreme event before the threshold is crossed. For example, a given weather pattern may be present for a few to several days before the 2 SD threshold is reached. Statistical significance is determined by comparing the probabilistic results to those obtained from a selected number, e.g., 100, samples of randomly selected days having identical sample sizes and monthly distributions.

For each year and NCEP variable, e.g., 850 mb temperature (“850 MB”), 10 mb temperature (“10 MB”), 500 mb geopotential height (“500 MB”), sea level pressure (“SLP”), 200 mb zonal wind (“200 MB”), and outgoing longwave radiation (“OLR”), the following information is provided graphically in the synoptic catalog. An example of a page from a synoptic catalog (500) is shown in FIG. 5a, (500) for nine principal components (Patterns 1-9), which represent a range of variance of :

1. The seasonal time series of the MI along with the 5- and 15-day running mean (502).

2. The time series of each of the principal components representing the temporal evolution of specific weather patterns (504).

3. A map of the weather pattern corresponding to the PC time series (506).

A visual comparison of the MI and PC time series may be generated to identify leading weather patterns in the historical record. These can be used for comparison with numerical weather forecasts to identify historic commonalities with current weather projections.

FIG. 5a illustrates a sample page from the synoptic catalog for 500 mb geopotential height for the 1981-1982 winter season. This example relates 500 mb geopotential height to the magnitude index (M.I., or S.C.I.) for severe cold weather, but could be generated for any number or combination of different atmospheric variables specified by the user and for additional types of extreme weather, e.g., heat waves. FIGS. 5b-5d provide more detailed images of the components of the synoptic catalog page of FIG. 5a, specifically showing weather pattern maps for nine weather patterns (EOF Patterns 1-9.) The column of maps on the right of each figure shows normalized data anomalies for days when the EOF pattern is strongest.

Synoptic catalogs can be constructed for any collection of years in which data is available.

### Significance of Leading Mode Probability (Step 112)

Significance testing and probabilistic analysis for the presence of atmospheric/surface patterns at various lead times to severe temperature outbreaks may be performed using each of the principal components (representing weather patterns) for the NCEP variables. These results can be compared against numerical weather forecasts for the purpose of assigning a probability that an extreme cold event will occur given the current or projected atmospheric/surface conditions.

The probability analysis may be conducted in two different ways: backward and forward.

Backward Analysis determines the probability that a severe event was preceded by a given weather pattern. The process is as follows:

1. The start and peak of each severe cold event is identified.

2. For each event, the phase (sign) of a given PC at n days leading through m days following the start or peak date of a severe cold event is recorded. n and m are user defined variables.

3. The probability that a pattern was present in its positive or negative at (t−n) to (t+m) is then calculated.

4. To calculate statistical significance, a resampling method is used in which these results are compared with those obtained using a sample of 1000 surrogate time series constructed to have the same mean, variance, and autocorrelation structure as a given PC (based on Tsonis, A. A., P. J. Roebber, and J. B. Elsner, 1999: Long-Range Correlations in the Extratropical Atmospheric Circulation: Origins and Implications. J. Climate, 12, 1534-1541).

5. The probability that a severe event was preceded by a given weather pattern may be presented graphically along with statistical significance.

Forward Analysis provides the probability that a synoptic event of a specified magnitude was followed by a severe event. This process is as follows:

1. Synoptic events are discretized by grouping consecutive days having like-signed anomalies into a discrete event.

2. A synoptic event of a given magnitude is said to occur if, at some point during the event, the magnitude of the PC time-series exceeds a threshold (zero or 1, 1.5, 2, or 2.5 standard deviations, where each threshold is considered separately). The use of n standard deviations as a threshold is designed to compliment weather forecast products, which display projected normalized anomalies in units of standard deviations above/below normal.

3. The first point in time at which the threshold is exceeded is taken as the reference point for comparison with the MI.

4. The percent of time a severe cold event follows the threshold crossing of a synoptic pattern at a user defined lag time is calculated and presented graphically with statistical significance.

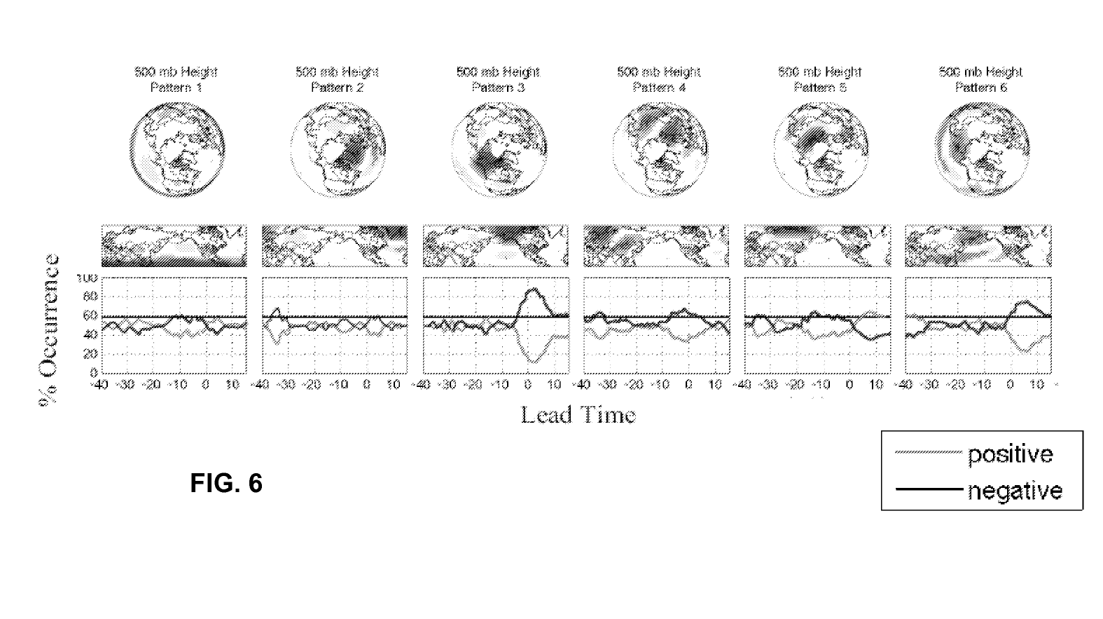

FIG. 6 is provides a set of plots showing the significance of leading modes for 500 mb geopotential height with respect to the occurrence of severe weather for Patterns 1-6. Values above the horizontal line at 60% are considered statistically significant. “Positive” and “negative” refer to the phase of the synoptic pattern shown in the maps corresponding to each pattern.

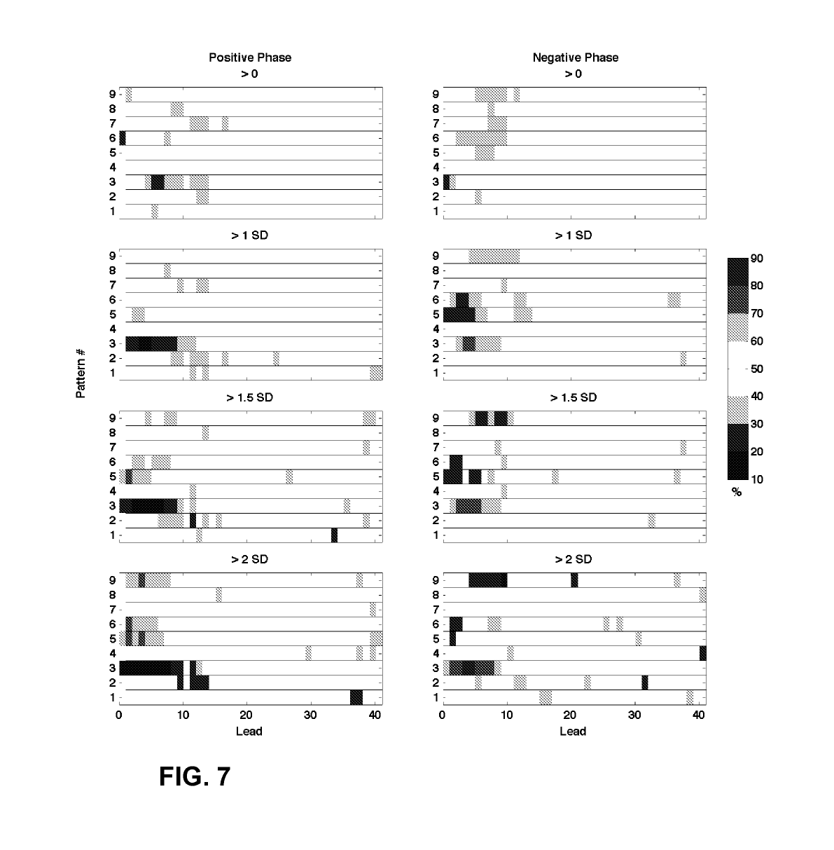

FIG. 7 provides an example of a probability (significance) plot showing the percent chance (occurrence) that extreme temperatures followed each of Patterns 1-9 in their positive or negative phases. The results are shown for 850 mb temperature, but may be generated for other NCEP variables. All shaded regions are statistically significant.

In step 114, the information sets selected by the user from those generated in steps described above may be displayed graphically at a user interface, e.g., as a printout or as monitor display. This historical data is used to generate synoptic patterns that may then be used for linking certain events (extreme cold or heat) with recent or current weather conditions to permit generation of a mid-range weather prediction. The maps and plots generated by the above algorithms may be viewed on a graphical display to assist the user in visualizing and recognizing historical weather patterns to improve medium range forecasts on the order of two weeks to a month or longer.

In step 120, via the user interface, the system user may select specific synoptic variables, the desired timeframe and the threshold or filter strength of the synoptic variable (e.g., 1 SD, 2 SD). The output can be the historic rate of occurrence of a severe weather event for the selected timeframe, e.g., and variable. The historic rate of occurrence may be measured as a percentage of the number of cases that resulted in an extreme weather event occurring during or following the selected timeframe. This value can be used provide a prediction of the probability of the severe weather event occurring over the specified timeframe.

The user may obtain current information for the synoptic variable(s) of interest for comparison against the leading modes of synoptic variability in the catalog. Comparisons may be performed either visually by a climatologist or meteorologist skilled in interpreting weather patterns, or by a computer system programmed with algorithms for recognizing and matching patterns within the data. In one embodiment, a computer system may be programmed to execute a learning algorithm such as a neural networks kernel machine, such as support vector machines, and other statistically-based systems that may be trained with the synoptic catalog to recognize certain patterns in new sets of data.

The following examples provide illustrations of the use of the inventive method for prediction and/or evaluation of the characteristics of extreme weather events.

### EXAMPLE 1

### Severe Cold Event

In an exemplary study, wintertime cold snaps over a large region of the Northeastern and Midwestern United States were considered according to how local cold temperature thresholds (5th percentiles of local wintertime temperature recorded at each of almost 500 stations) are exceeded on daily timescales. A regional magnitude index reflecting the temperature intensity, duration and spatial extent of extreme cold spells is computed for 61 winters from 1948-49 to 2008-09 and for each day of each event. Observed variability of regional cold spells was then examined on timescales ranging from daily to interdecadal and evaluated with respect to the climatic controls on their synoptic causes. Relationships with known climate modes (ENSO, NAO, PDO, PSV, etc.) as well as other relevant objectively derived circulation and land-surface patterns may then be used to develop sophisticated models and simple rule-of-thumb techniques for seasonal and improved medium-range probabilistic prediction of cold snap magnitude. Anthropogenic forcing is assessed and integrated into the predictive methodology. The main components of cold spells, i.e., intensity, duration and spatial extent, are explicitly considered. These forecasting tools are designed for straightforward operational application by practicing meteorologists working in energy load forecasting.

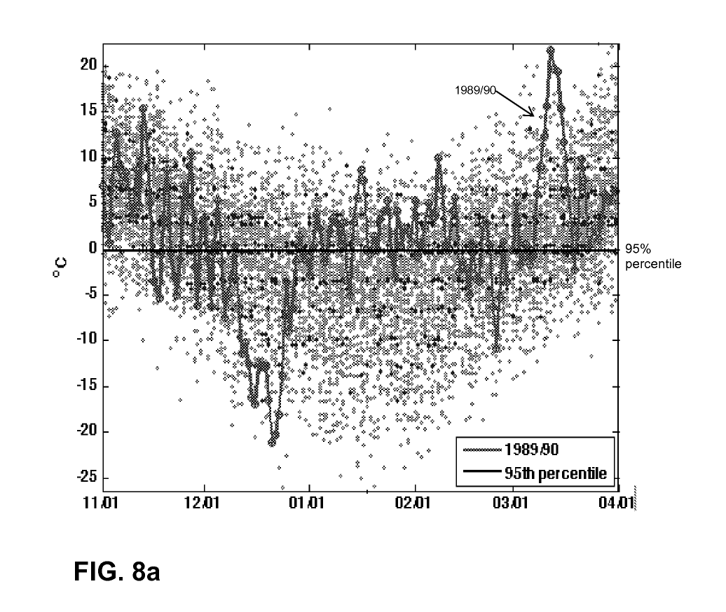

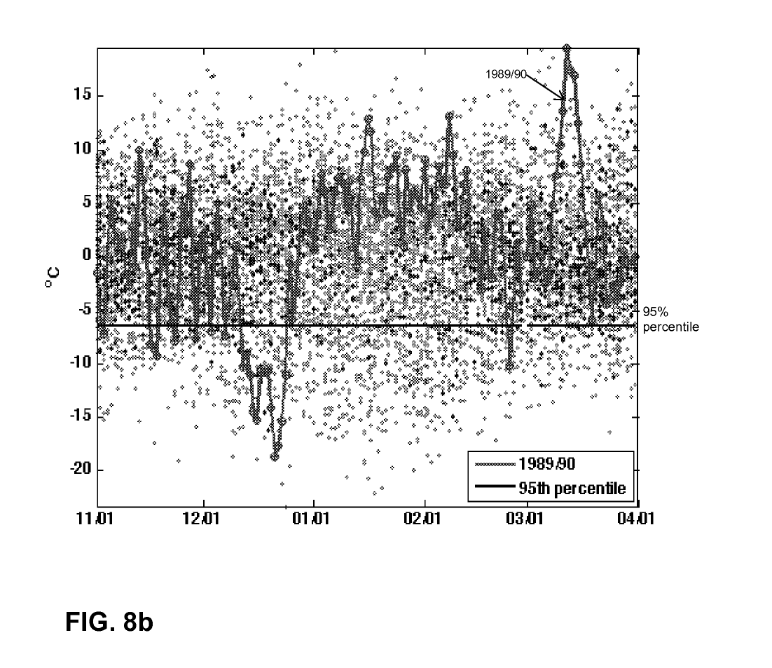

Using historical station data from 1948-2008, a local threshold was calculated for each station (5th percentile). For each day and station, the number of degrees below the threshold was recorded. In FIGS. 8a and 8b, observed daily mean temperature (8a) and temperature anomalies (8b) are plotted for each date in winter as measured at a selected station. Measurements for 1989-1990 are highlighted as an example, and the 95^{th} percentile is selected as the threshold. Data from all stations and all dates in the selected range are collected.

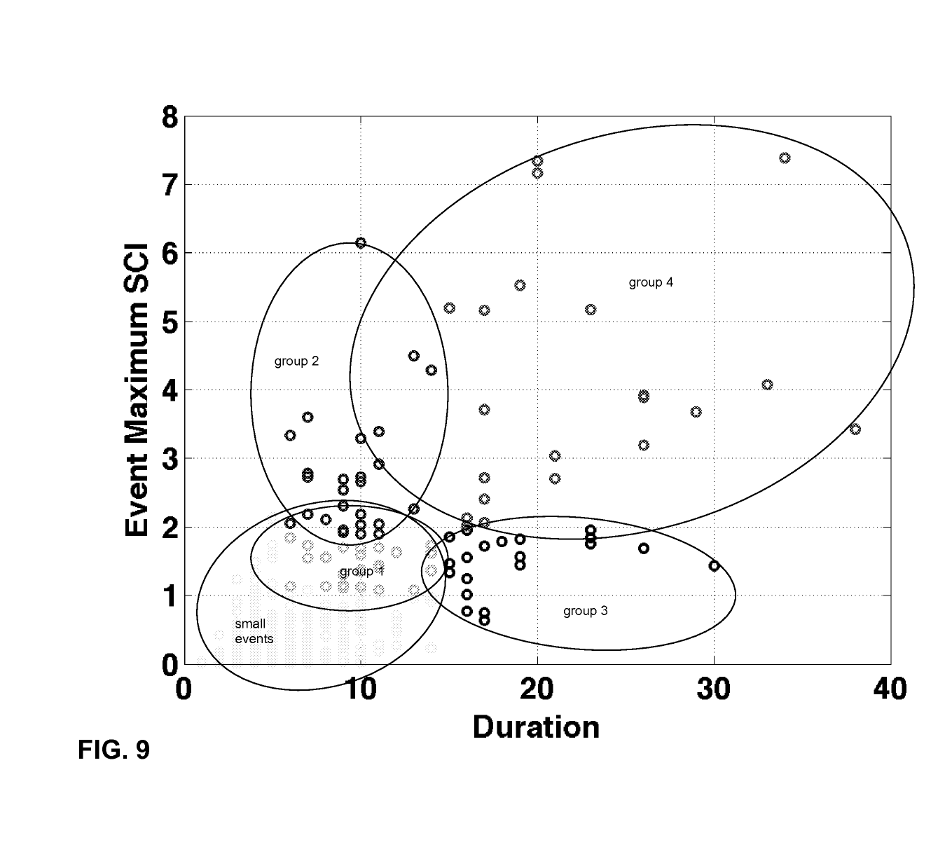

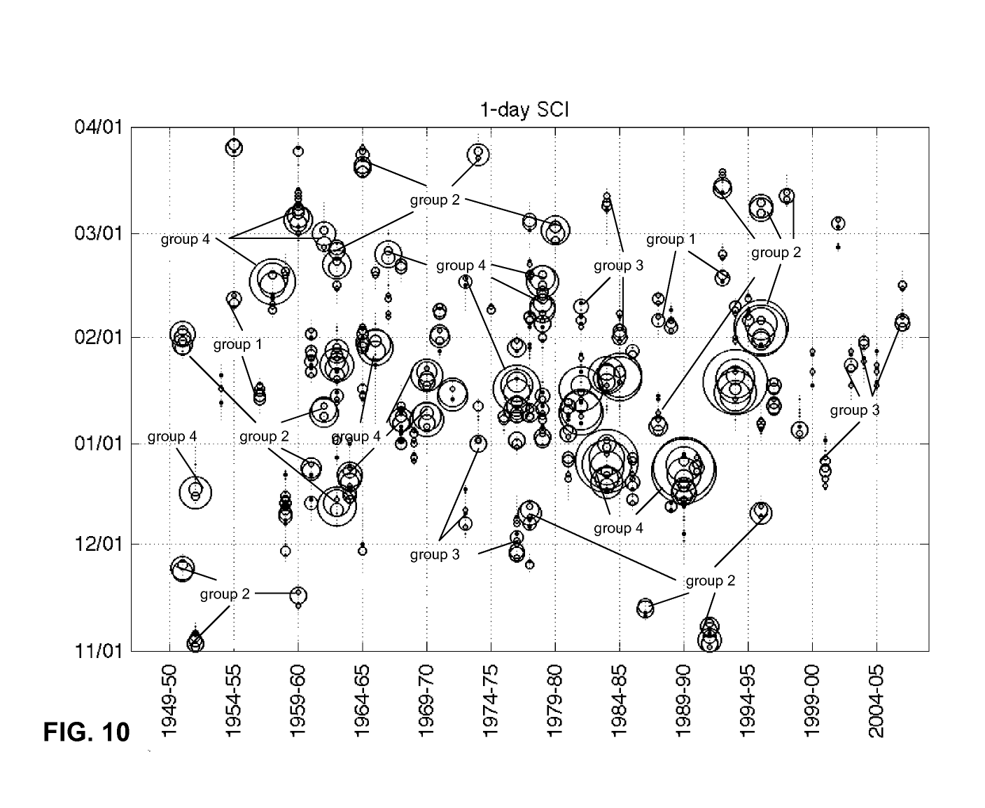

The MI (magnitude index), or in this case, the SCI (severe cold index), is the average of all local threshold exceedances of the selected threshold and is plotted. See, FIG. 3. MI (or SCI) is plotted for each year and each day. The diameter of each circle represents the value of the MI (SCI). Events of different duration, e.g., medium and long, may optionally be plotted separately by using, for example, different colors or symbols. Alternatively, events may be grouped according to the MI (or SCI), then plotted against other parameters. FIG. 9 is a plot of event maximum SCI and duration for five different groups: groups 1-4 and “small events” (low MI). FIG. 10 shows the MI (SCI) broken into the different groups of FIG. 9.

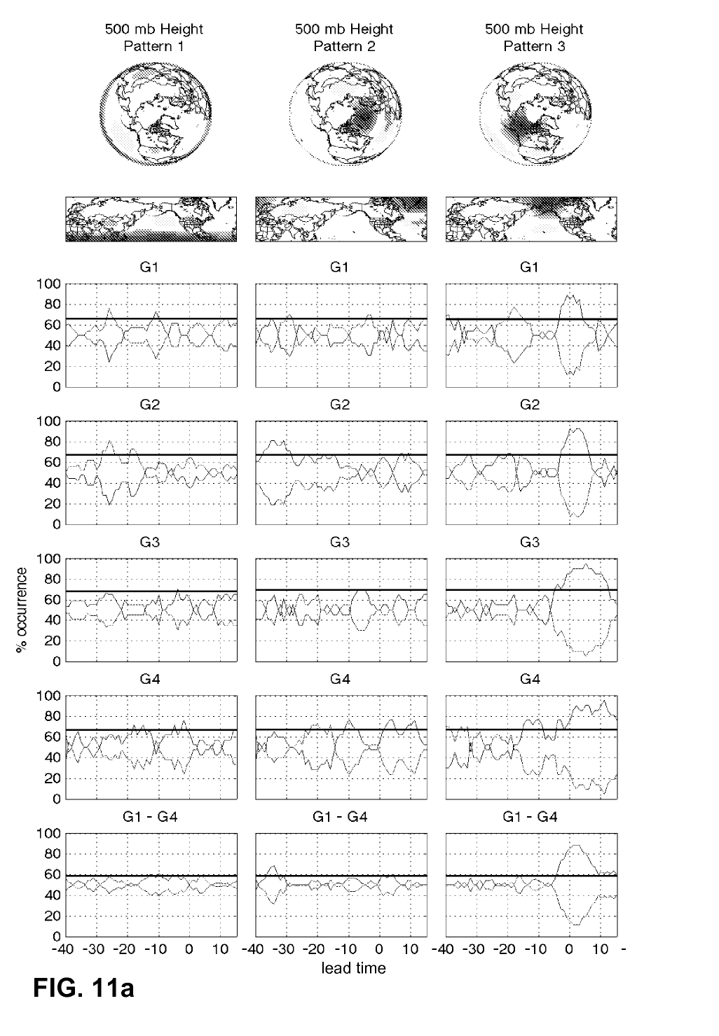

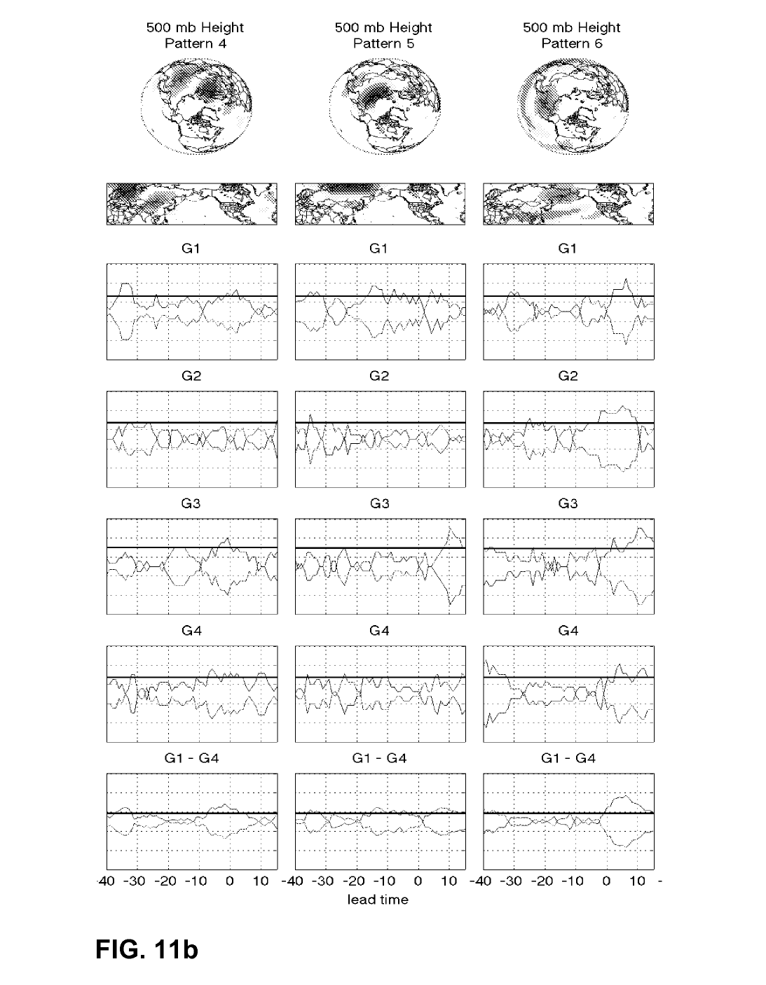

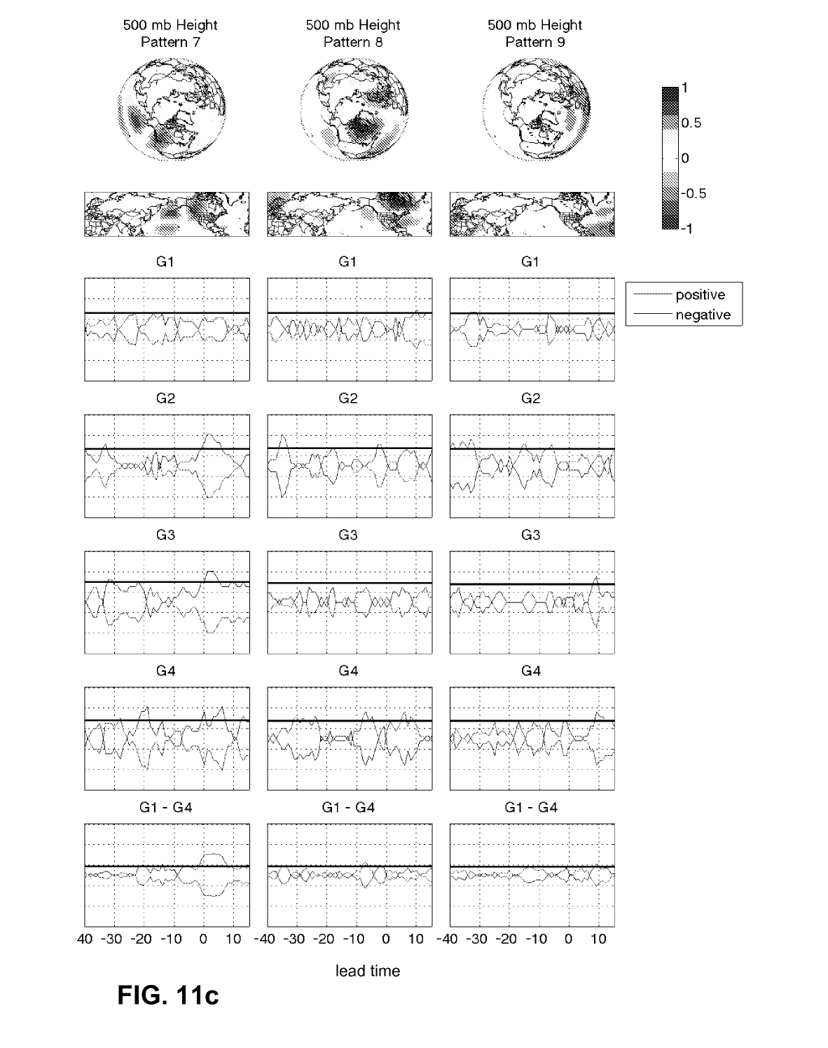

Synoptic precursors and predictability are generated from historical atmospheric and surface data from NCEP Reanalysis for parameters including 850 mb temperature, 10 mb temperature, 500 mb geopotential height, sea level pressure, 200 mb zonal wind and outgoing longwave radiation. A synoptic catalog page is generated for the nine different EOFs in the form shown in FIGS. 5a-5d. Synoptic precursors are calculated as previously described to determine the probability that a severe cold event was preceded by a given weather pattern. Plots are generated for different lead times for each pattern for each individual group of groups 1-4 of FIG. 9 and for the combination of groups 1-4. The plots for 500 mb geopotential height are shown in FIGS. 11a-11c.

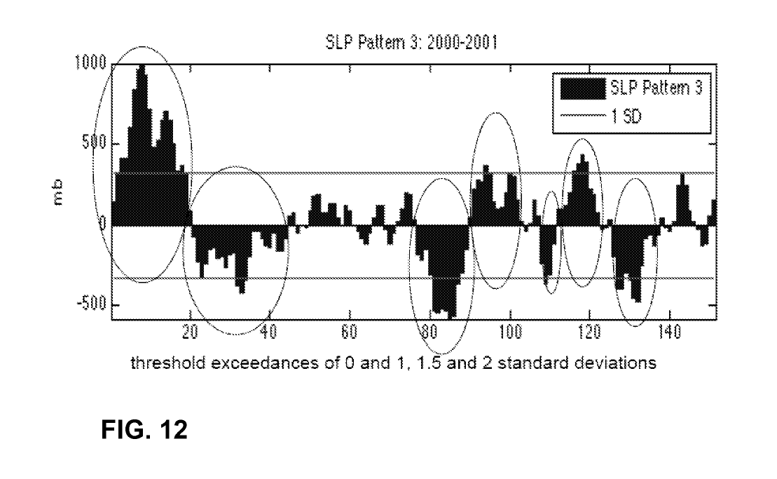

Synoptic events are identified within each EOF pattern by determining the threshold exceedance of the magnitudes of the PC time-series. Thresholds are selected as zero and 1, 1.5, and 2 standard deviations, where each threshold is considered separately. FIG. 12 is a plot comparing the magnitudes in Pattern 3 for sea level pressure relative to a threshold of 1 standard deviation. The circled areas indicate exceedances.

The probability that a synoptic event of a given magnitude was followed by a severe cold event is calculated as described above and plotted for each threshold, for each pattern. FIG. 7 illustrates such a plot for 500 mb geopotential height for lead times from zero to 40 days. All shaded areas are considered statistically significant.

FIG. 13 illustrates an example of a page from a synoptic catalog for the nine patterns for 850 mb temperature showing the seasonal time series of the MI (SCI) along with the 5- and 15-day running mean, the time series of each of the principal components representing the temporal evolution of specific weather patterns, and maps for each weather pattern corresponding to the PC time series.

The resulting synoptic catalog can be compared against recent or current weather conditions to determine the probability of a severe cold event occurring. For example, historically, when a strong (greater than 2 standard deviations above normal) surface high pressure develops over the North Atlantic area (Greenland and Canada), coincident with a strong surface low pressure zone (>2 SD below normal) in the western Atlantic and over Europe, more than 45% of the time, a severe cold event followed 30-40 days later. Thus, if these conditions were present at a given time, one could predict that there would be a cold outbreak in Europe in 30-40 days from that time.

### EXAMPLE 2

### Extreme Cold Winter of 2009-10

The winter of 2009-2010 made headlines for its fierce snowstorms and brutally cold temperatures. According to the UK Meteorological Office, England and Wales suffered their coldest winter since 1978-79, and Scotland saw temperatures not seen since the 1960's. Miami Beach, Fla., recorded its coldest January-February since records began in 1937, and Baltimore, Md., Washington, D.C., Wilmington, Del., and Philadelphia, Pa., all set seasonal snowfall records. An examination of Northern Hemisphere cold and warm temperature extremes using the inventive method reveals that while the cold events and their disruptive impacts received the bulk of the attention, warm extremes actually dominated much of the Northern Hemisphere when viewed in a historical context.

To identify extreme temperature events, local and regional extreme cold and warm temperature indices were calculated using 995 mb temperature data from NCEP Reanalysis. A local “Severe Cold Index” (SCI) was defined as described above. This index is calculated from deseasonalized (by fitting and removing annual and semiannual harmonics) daily temperature data at a grid cell based on a local threshold exceedance. The threshold is the cold-season 5^{th} percentile over the base period of 1950-1999, where the cold season is taken as November 1^{st} through March 31^{st}. A local “Severe Warm Index” (SWI) is calculated in the same way but uses the 95^{th} percentile as the threshold level. A regional SCI/SWI is then obtained for any area of interest as the spatial average of the local SCI/SWI. Eight regions, covering the Northern Hemisphere continental mid-latitudes were studied: Canada, U.S., Alaska/Yukon, Far East, Siberia, Central Asia, Northern Europe/Russia, and Mediterranean/Middle East. In addition, Eurasia and North America were taken together, referred to as the “Northern Continents”, represented by the average of the eight regions. A seasonal SCl/SWI was obtained by summing the regional daily values over each winter and was used to compare 2009-10 against the historical record. This seasonal index encompasses the magnitude and spatial extent as well as duration and recurrence. The results from the Reanalysis were verified against high-quality station data over the Midwestern and Eastern U.S.

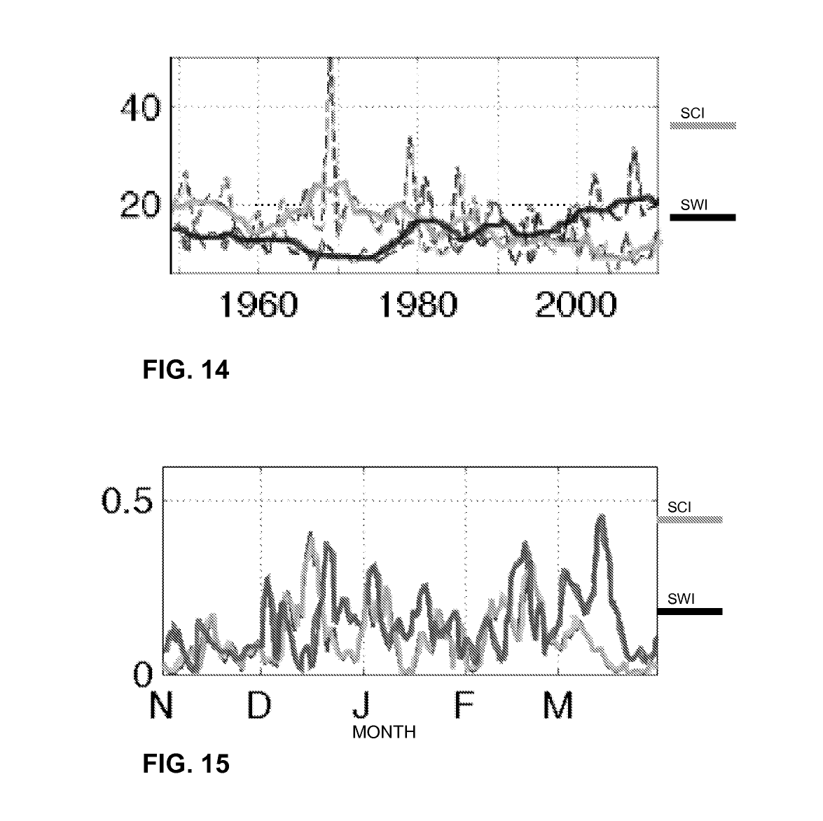

Data going back to 1948 show that for the Northern Continents cold events were more extreme in each of the previous decades than they have been since 2000, as shown in FIG. 14, where the solid lines give the 2-point running mean.

In fact, cold events have been declining steadily since the 1970's. Additionally, recent years have seen an increase in the overall magnitude of extreme warm events. For some regions, the past winter saw stronger and more frequent warm events than most or all years past. The recent tendency for extreme warm events to exceed extreme cold holds in general for the winter of 2009-2010, as shown in FIG. 15, with exceptions seen for Northern Europe/Russia and Siberia, where cold events dominated, and in the U.S. and Alaska/Yukon, where the warm and cold indices were nearly equal. Elsewhere such as Canada, Central Asia, the Mediterranean/Middle East, and for the Northern Continents as a whole, extreme warm weather dominated in 2009-2010. This winter's warm and cold temperature extremes were consistent with the general observed warming trend, and the typical assumption that a warming of the seasonal mean temperature leads to a distribution shift that yields more/stronger warm extremes and fewer/weaker cold ones. This is seen hemispherically, however, not all regions conformed to this pattern in 2009-2010 or are expected to conform in any particular winter.

The Northern Continents as a whole saw more/stronger cold events during the winter of 2009-2010 than have occurred since 1998-1999, ranking this winter in the top third in terms of seasonal cold extremes. However, the warm events were more severe and widespread than the cold ones. This past winter ranked among the top four winters in terms of extreme warm weather, and locally, the magnitude of warm evens exceeded that of the cold events. Spatially, there were many more localities experiencing very extreme warm conditions than were experiencing extreme cold.

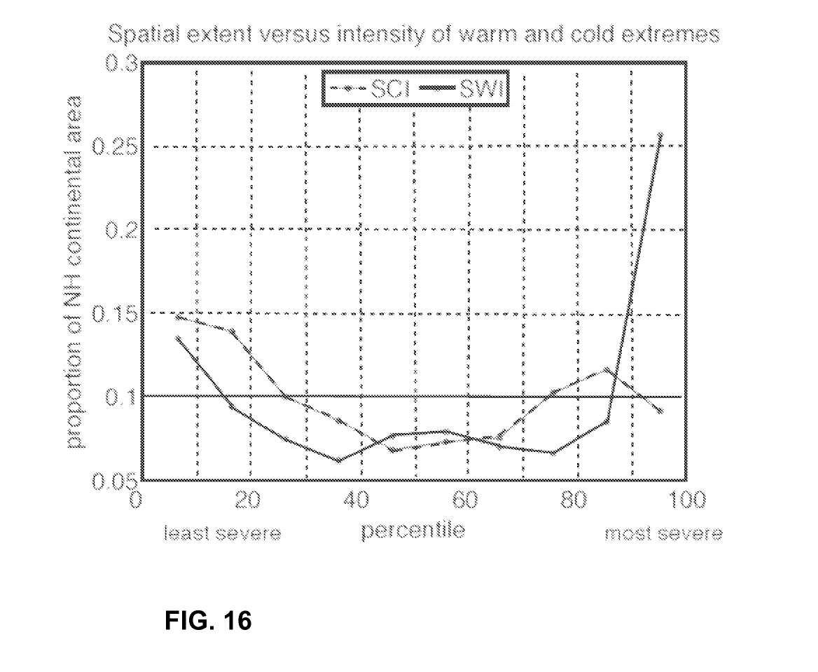

Approximately 25% of the Northern Hemisphere continental area (2.5 times the expected area) saw warm extremes in the upper 10% of the 62-year winter climatology (most severe category, i.e., ranked among the 6.2 warmest extreme winters.) Meanwhile, the coldest extremes were no more spatially extensive than climatologically expected (i.e., nearly 10% area for each of the three coldest categories/bins.) In summary, the past winter's cold extremes were, on areal average, not remarkably different from climatology, while the warm extremes tended to be much more severe than in an average winter. FIG. 16 is a plot of the spatial extent versus intensity of warm and cold extremes. The proportion of Northern Hemisphere continental area where observed SCI and SWI index values in 2009-2010 fell within a percentile range binned by 10% increments of their respective climatologies. Empirical SCI and SWI percentiles were calculated using the 62-year record at each continental grid cell, so that the expected climatological, i.e., for an average winter, value for each bin is 0.1 (10% of the area, indicated by the horizontal line at 0.1), since each year's extreme index values have the expected probability of 10% of falling into each of the ten bins by construction.

Northern Europe and Russia clearly experienced some very extreme cold spells during 2009-2010, and the winter as a whole was among the top ten in terms of severe cold outbreaks (the coldest since 1998-1999.) In Siberia, 2009-2010 also ranked among the top ten in terms of cold severity. Here, the coldest day was not nearly as extreme as the winter as a whole, so it was persistence/recurrence of events that drove the overall cold conditions in Siberia as opposed to the severity of individual cold days. Central Asia experienced repeated extreme warm and cold events occurring nearly simultaneously in different parts of the region. Here, this past winter ranked among the top 15 in terms of extreme cold, however, the extreme warmth was much more sever, ranking second only to that in 2001-2002. The data for U.S., Alaska/Yukon, and the Far East show a relatively mild winter during 2009-2010, with 75% of previous winters seeing more frequent/stronger cold spells. The Mediterranean/Middle East saw more frequent/ stronger warm extremes during this winter than in any other winter since 1948, and the seasonal extreme warmth in Canada has been topped only once, during the winter of 1980-1981.

Arguably, the most noteworthy regional circulation feature during this past winter was the North Atlantic Oscillation (NAO), which reached and maintained record low index values during the winter of 2009-2010. In its negative phase, the NAO is associated with Northern Hemisphere blocking patterns that support cold air outbreaks in the Eastern U.S. and Northern Eurasia and warmer conditions elsewhere. An interesting observation from 2009-2010 is that while the extreme cold events were largely explainable by the NAO, the extreme warm spells were not. For example, the magnitude of the 2009-2010 seasonal SCI as compared to the 62-year record shows that Europe, Russia, and parts of Central Asia were slightly colder than normal with isolated parts being very cold. However, when compared to ten winters having the most negative NAO (excluding 2009-2010) the Northern Hemisphere generally appears to have been on the warm side of normal in terms of the seasonal SCI, which is especially interesting given that the NAO in 2009-2010 was so anomalous. The extreme warm events, however, are not explained by the state of the NAO, as the winter of 2009-2010 appears extremely warm in many parts, both with respect to the long-term record, and relative to negative NAO winters.

The winter of 2009-2010 brought extreme cold weather and much snow to parts of Europe and the Southeastern U.S., causing disruptions to traffic, infrastructure, and day-to-day life not seen in recent years. This lead to widespread speculation about whether this winter marked a return to the more severe winter conditions seen in the 1970′s and 1980′s. Using the inventive method, the temperature extremes of the 2009-2010 winter was compared with long term behavior. Cold weather extremes did indeed manifest, breaking some long-terms records locally. However, these were exceptional cases explained by the anomalous negative NAO. The larger picture shows that warm events occurring during the winter of 2009-2010 were much more extreme that the cold events, and the Northern Hemisphere continental mid-latitudes as a whole were warmer than 59 of the 62 years on record.

The inventive process will allow users to assess financial risks by testing how different climate scenarios might affect the probability of a severe weather event in a given region over a timescale of one to 40 days in the future. Access to this kind of information could give energy companies an edge when purchasing natural gas futures, for example, a savings that would also be realized by utility customers. The ability to better forecast weather extremes could also help marketers of weather-related products strategize when to run ad campaigns, and distributors of those products to plan ahead to stock up on inventory. Further, when used by local governments, the present invention will allow advance preparations for staging of maintenance and emergency personnel and equipment for optimal response to weather-related emergencies.
The disclosures of the following references are incorporated herein by reference:

Bosart, L. F. and F. Sanders, 1986: Mesoscale Structure in the Megalopolitan Snowstorm of 11-12 Feb. 1983. Part III: A Large-Amplitude Gravity Wave. J. Atmos. Sci., 43, 924-939.

Downton, M. W., and K. A. Miller, 1993: The freeze risk to Florida citrus. Part II: Temperature variability and circulation patterns. J. Climate, 6, 364-372.

Grumm R. H., and R. Hart, 2001: Standardized anomalies applied to significant cold season weather events: Preliminary findings. Wea. Forecasting, 16, 736-754

Konrad, C., 1996: Relationships between the intensity of cold-air outbreaks and the evolution of synoptic and planetary-scale features over North America. Mon. Wea. Rev., 124, 1067-1083.

Konrad, C. E. and S. J. Colucci, 1989: An examination of extreme cold air outbreaks over eastern North America. Mon. Wea. Rev., 117, 2678-2700.

Mogil, H. M., A. Stern, and R. Hagan, 1984: The great freeze of 1983: Analyzing the causes and the effects. Weatherise, 37, 304-308.

Quiroz, R. S., 1984: The climate of the 1983-84 winter—A season of strong blocking and severe cold in North America. Mon. Wea. Rev., 112, 1894-1912.

Rogers, J. C., and R. V. Rohli, 1991: Florida citrus freezes and polar anticyclones in the Great Plains. J. Climate, 4, 1103-1113.

Walsh, J. E., A. S. Phillips, D. H. Portis, and W. L. Chapman, 2001: Extreme Cold Outbreaks in the United States and Europe, 1948-99., 14, 2642-265

Wagner, J. A., 1977: Weather and circulation of January 1977—The coldest month on record in the Ohio Valley. Mon. Wea. Rev., 105, 553-560.

1. A method for prediction of extreme weather events, the method comprising:
generating a catalog of synoptic precursors by:
collecting historical weather data over a period of record for one or more selected regions, the data comprising intensity, duration and spatial extent, wherein a plurality of local data sources are located within the one or more selected regions;
calculating a local magnitude index for each local data source;
calculating a regional magnitude index using the local magnitude index for the plurality of local data sources within the selected region;
using the magnitude index to perform one or more of the following:
creating composite maps of global weather patterns at leading and lagging timescales for one or more pre-defined weather variables;
generating significance plots of the significance of leading modes in atmospheric variability across the period of record for the one or more pre-defined weather variables;
generating time series graphical plots and event sets which define independent events according to intensity, spatial extent and duration for different durations and dates for the one or more pre-defined weather variables;
generating a synoptic catalog for each of the one or more pre-defined weather variables by determining the significance of leading modes in atmospheric variability across a user-defined period of time; and
generating a graphical display at a user interface of one or more of the composite maps, significance plots, time series graphical plots and the synoptic catalog for use in a probabilistic projection that an extreme weather event will occur based on recent or current weather conditions.

2. The method of claim 1, wherein the local magnitude index for a daily record is calculated according the relationship Mₜₕᵣₑₛₕ^{j,s,d}=(T_{s,d,j}−Tₜₕᵣₑₛₕ^{j}) if T_{s,d,j}>Tₜₕᵣₑₛₕ^{j}, and zero otherwise, where thresh is the threshold percentage, j is the local data source and j=1, . . . , N, d is a specified date and s is a specified season, and T is the temperature.

3. The method of claim 2, wherein the regional magnitude index for a daily record is calculated according to the relationship Mₜₕᵣₑₛₕ^{s,d}=Σⱼ(Mₜₕᵣₑₛₕ^{j,s,d})/N, where N is a number of local data sources.

4. The method of claim 2, wherein the local magnitude index for a specified event duration is calculated according to the relationship M*ₜₕᵣₑₛₕ^{j}=Σₛ*_{,d}*(Mₜₕᵣₑₛₕ^{j,s,d}) and the regional magnitude index is M*ₜₕᵣₑₛₕ=Σ_{j,s}*_{,d}*(Mₜₕᵣₑₛₕ^{j,s,d})/N.

5. The method of claim 1, wherein the pre-defined weather variables comprise the NCEP variables.

6. The method of claim 5, wherein the NCEP variables comprise 850 mb temperature (“850 MB”), 10 mb temperature (“10 MB”), 500 mb geopotential height (“500 MB”), sea level pressure (“SLP”), 200 mb zonal wind (“200 MB”), and outgoing longwave radiation (“OLR”).

7. A system for prediction of extreme weather events, the system comprising:
a central server;
a database for storing historical weather data comprising intensity, duration and spatial extent of weather conditions;
a plurality of local measurement stations disposed within one or more regions;
a user interface comprising a graphical display;
a networked connection providing data communication between the central server, the database, the plurality of local measurement stations and the user interface, wherein the central server is programmed to execute the steps of:
collecting historical weather data over a period of record for the one or more regions, the data comprising intensity, duration and spatial extent;
calculating a local magnitude index for each local measurement station;
calculating a regional magnitude index using the local magnitude index for the plurality of local measurement stations within the one or more regions;
using the magnitude index to perform one or more of the following:
creating composite maps of global weather patterns at leading and lagging timescales for one or more pre-defined weather variables;
generating significance plots of the significance of leading modes in atmospheric variability across the period of record for the one or more pre-defined weather variables;
generating time series graphical plots and event sets which define independent events according to intensity, spatial extent and duration for different durations and dates for the one or more pre-defined weather variables;
generating a synoptic catalog for each of the one or more pre-defined weather variables by determining the significance of leading modes in atmospheric variability across a user-defined period of time; and
generating a graphical display at the user interface of one or more of the composite maps, significance plots, time series graphical plots and the synoptic catalog for use in a probabilistic projection that an extreme weather event will occur based on recent or current weather conditions.

8. The method of claim 7, wherein the local magnitude index for a daily record is calculated according the relationship Mₜₕᵣₑₛₕ^{j,s,d}=(T_{s,d,j}−Tₜₕᵣₑₛₕ^{j}) if T_{s,d,j}>Tₜₕᵣₑₛₕ^{j}, and zero otherwise, where thresh is the threshold percentage, j is the local measurement station and j=1, . . . , N, d is a specified date and s is a specified season, and T is the temperature.

9. The method of claim 8, wherein the regional magnitude index for a daily record is calculated according to the relationship Mₜₕᵣₑₛₕ^{s,d}=Σⱼ(Mₜₕᵣₑₛₕ^{j,s,d})/N, where N is a number of local data sources.

10. The method of claim 8, wherein the local magnitude index for a specified event duration is calculated according to the relationship M*ₜₕᵣₑₛₕ^{j}=Σₛ*_{,d}*(Mₜₕᵣₑₛₕ^{j,s,d}) and the regional magnitude index is M*ₜₕᵣₑₛₕ=Σ_{j,s}*_{,d}*(Mₜₕᵣₑₛₕ^{j,s,d})/N.

11. The method of claim 7, wherein the pre-defined weather variables comprise the NCEP variables.

12. The method of claim 11, wherein the NCEP variables comprise 850 mb temperature (“850 MB”), 10 mb temperature (“10 MB”), 500 mb geopotential height (“500 MB”), sea level pressure (“SLP”), 200 mb zonal wind (“200 MB”), and outgoing longwave radiation (“OLR”).

13. A computer program product embodied on a computer readable medium for predicting extreme weather events, the computer program product comprising instructions for causing a computer processor to:
collect historical weather data over a period of record for one or more selected regions, the data comprising intensity, duration and spatial extent, wherein a plurality of local data sources are located within the one or more selected regions;
calculate a local magnitude index for each local data source;
calculate a regional magnitude index using the local magnitude index for the plurality of local data sources within the selected region;
using the magnitude index to perform one or more of the following:
create composite maps of global weather patterns at leading and lagging timescales for one or more pre-defined weather variables;
generate significance plots of the significance of leading modes in atmospheric variability across the period of record for the one or more pre-defined weather variables;
generate time series graphical plots and event sets which define independent events according to intensity, spatial extent and duration for different durations and dates for the one or more pre-defined weather variables;
generate a synoptic catalog for each of the one or more pre-defined weather variables by determining the significance of leading modes in atmospheric variability across a user-defined period of time; and
generate a graphical display at a user interface of one or more of the composite maps, significance plots, time series graphical plots and the synoptic catalog for use in a probabilistic projection that an extreme weather event will occur based on recent or current weather conditions.

14. The method of claim 13, wherein the local magnitude index for a daily record is calculated according the relationship Mₜₕᵣₑₛₕ^{j,s,d}=(T_{s,d,j}−Tₜₕᵣₑₛₕ^{j}) if T_{s,d,j}>Tₜₕᵣₑₛₕ^{j}, and zero otherwise, where thresh is the threshold percentage, j is the local data source and j=1, . . . , N, d is a specified date and s is a specified season, and T is the temperature.

15. The method of claim 14, wherein the regional magnitude index for a daily record is calculated according to the relationship Mₜₕᵣₑₛₕ^{s,d}=Σⱼ(Mₜₕᵣₑₛₕ^{j,s,d})/N, where N is a number of local data source.

16. The method of claim 14, wherein the local magnitude index for a specified event duration is calculated according to the relationship M*ₜₕᵣₑₛₕ^{j}=Σₛ*_{,d}*(Mₜₕᵣₑₛₕ^{j,s,d}) and the regional magnitude index is M*ₜₕᵣₑₛₕ=Σ_{j,s}*_{,d}*(Mₜₕᵣₑₛₕ^{j,s,d})/N.

17. The method of claim 13, wherein the pre-defined weather variables comprise the NCEP variables.

18. The method of claim 17, wherein the NCEP variables comprise 850 mb temperature (“850 MB”), 10 mb temperature (“10 MB”), 500 mb geopotential height (“500 MB”), sea level pressure (“SLP”), 200 mb zonal wind (“200 MB”), and outgoing longwave radiation (“OLR”).
